(19) United States
(12) Patent Application Publication
(10) Pub. No.: US 2024/0001235 A1
(43) Pub. Date: Jan. 4, 2024

(54) SERVER DEVICE AND INFORMATION PROVIDING METHOD

(71) Applicant: Sony Interactive Entertainment Inc., Tokyo (JP)

(72) Inventor: Takayuki Ochi, Kanagawa (JP)

(73) Assignee: Sony Interactive Entertainment Inc., Tokyo (JP)

(21) Appl. No.: 18/333,686

(22) Filed: Jun. 13, 2023

(30) Foreign Application Priority Data
Jun. 30, 2022 (JP) 2022-105835

(51) Int. Cl. A63F 13/533; A63F 13/35

(52) U.S. Cl. CPC A63F 13/533; A63F 13/35

(57) ABSTRACT

Disclosed herein is a server device including a recording device which records pieces of past play data of a plurality of players on a second game having a predetermined relation to a first game, and one or more processors having hardware. The one or more processors analyze the pieces of past play data on the second game and obtain information indicating a play history relating to a plurality of play units to each of which an end condition is set in the second game, specify a second play unit in the second game which is similar to the first play unit in the first game, and generate information relating to the first play unit in the first game, on the basis of the information indicating the obtained play history relating to the second play unit in the second game.

### CROSS REFERENCE TO RELATED APPLICATIONS

This application claims the benefit of Japanese Priority Patent Application JP 2022-105835 filed Jun. 30, 2022, the entire contents of which are incorporated herein by reference.

### BACKGROUND

The present disclosure relates to a technique for providing information relating to a game to a user.

Japanese Patent Laid-Open No. 2022-63756 discloses a server device that processes pieces of event data relating to an activity performed by a plurality of players. This server device obtains lengths of playing time for an activity performed by the plurality of players from a plurality of pieces of event data, sorting the players into any one of a plurality of classes according to a skill value of each player, to thereby determine a representative value of the playing time in each class, on the basis of the lengths of playing time of the plurality of players in each class. The server device notifies a user of the estimated playing time based on the representative value of the playing time associated with the class of the user.

Japanese Patent Laid-Open No. 2022-57395 discloses a server device which supports acquisition of a trophy that is a virtual reward for a user. This server device extracts, in advance, a relation on a trophy acquisition order on the basis of an order of acquiring a plurality of trophies by a plurality of players, and notifies the user of information relating to a trophy that would next be acquired by the user, in reference to the extracted relation.

### SUMMARY

Collecting pieces of data (play data) of a plurality of players having played a game by the server device makes it possible to derive various types of information through statistical processing, thereby allowing the information to be provided to the user. However, in a case of a game that it has not been that long since the game was released or in a case of a game played by a few users, the server device has not been able to collect enough play data, and accordingly, it is not easy to derive information with high accuracy from only play data on the game.

In view of this, according to an embodiment of the present disclosure, it is desirable to provide a technique for providing useful information regarding the game to a user, even if play data on the game has not been sufficiently collected.

According to a mode of the present disclosure, there is a server device including a recording device which records pieces of past play data of a plurality of players on a second game having a predetermined relation to a first game, and one or more processors having hardware. One or more processors analyze the pieces of past play data on the second game and obtain information indicating a play history relating to a plurality of play units to each of which an end condition is set in the second game, specify a second play unit in the second game which is similar to the first play unit in the first game, and generate information relating to the first play unit in the first game, on the basis of the information indicating the obtained play history relating to the second play unit in the second game.

Another mode of the present disclosure is a method of providing information to a user, the method including analyzing pieces of past play data of a plurality of players on a second game having a predetermined relation to a first game to obtain information indicating a play history relating to a plurality of play units to each of which an end condition is set in the second game, specifying a second play unit in the second game which is similar to a first play unit in the first game, generating information relating to the first play unit in the first game, on the basis of the information indicating the obtained play history relating to the second play unit in the second game, and providing the information relating to the first play unit in the first game to a user.

It is noted that any combinations of the constituent components described above and the expressions of the present disclosure that are converted between an apparatus, a system, a recording medium, a computer program, and the like are also effective as modes of the present disclosure.

### BRIEF DESCRIPTION OF THE DRAWINGS

FIG. 1 is a diagram illustrating an information processing system according to an embodiment of the present disclosure;

FIG. 2 is a block diagram illustrating a hardware configuration of an information processing device;

FIG. 3 is a block diagram illustrating functional blocks of the information processing device;

FIG. 4 is a block diagram illustrating functional blocks of a server device;

FIG. 5 is a diagram used for describing a calculation method for a playing time;

FIG. 6 is a diagram used for describing a calculation method for a play timing;

FIG. 7 is a diagram used for describing a process of specifying similar activities;

FIG. 8 is a view illustrating an example of a system screen; and

FIG. 9 is a view illustrating an example of a system screen.

### DETAILED DESCRIPTION OF THE PREFERRED EMBODIMENT

An outline of an embodiment of the present disclosure will be described. In the embodiment, an information processing device as a user terminal device executes game software. When an event occurs in a game, the game software outputs event information identifying the event having occurred to system software. An event occurs when there is a change in a progress of a gameplay or there is a change in an action by a game character, for example.

Game software includes a plurality of play units to each of which an end condition is set. The play unit may have a start condition set thereto, and in this case, a game play performed from a timing at which the start condition is satisfied to a timing at which the end condition is satisfied constitutes one play unit.

The play unit may include a stage, a quest, a mission, a tournament, a session, and the like which are incorporated in the game. The play unit is set by a game manufacturer as needed, and for example, one quest appearing in the progress of the game may include one play unit, or a plurality of quests appearing as the game advances may include one play unit. In a case in which a plurality of quests include one play unit, completing all of the plurality of quests becomes the end condition of the play unit.

The game software in the embodiment includes, as a kind of play unit, an activity to which the end condition is set. The activity may include the stage, quest, mission, tournament, session, and the like described above. Note that the game manufacturer may set all of the stage, the quest, the mission, the tournament, the session which are incorporated in the game as the activity. However, only some of the stage, the quest, the mission, the tournament, and the session may be set as the activity. As described above, a combination of a plurality of quests and a plurality of missions may be set as one activity, constituting one play unit.

When an activity is started, the game software outputs event information including an activity identifier (activity ID) identifying the activity and information indicating the start of the activity to the system software. When the activity is ended, the game software outputs event information including the activity ID and information indicating the end of the activity to the system software. At the end of the activity, the game software may include the results (success or failure) of the activity in the event information. The system software generates event data obtained by adding a user identifier (user account) which identifies the user, a game identifier (game ID) which identifies the game, and time information (a time stamp) are added to the event information output from the game software, and transmits the generated event data to an external server device.

In addition, the game software sets, as a kind of play unit, various types of quests and missions (hereinafter, simply referred to as a “mission”) for acquiring a trophy that is a virtual reward. When the user completes a mission, a trophy corresponding to the mission is rewarded to the user. The end condition of the mission is a play condition of releasing the trophy to the user and is also referred to as a trophy “unlock condition.” A determination whether to end the trophy mission is made by the system software determining whether or not the trophy unlock condition is succeeded, on the basis of the event information output from the game software. The system software transmits the unlocked trophy acquisition information to the external server device.

The server device collects pieces of event data transmitted from a plurality of information processing devices operated by a plurality of players and analyzes play trends relating to an activity. For example, the server device may statistically process the lengths of playing time of the plurality of players for the activity, on the basis of the pieces of event data transmitted from the plurality of information processing devices. In addition, the server device may statistically derive a timing at which a plurality of activities are performed in one game and an order of performing the plurality of activities, on the basis of the pieces of event data transmitted from the plurality of information processing devices.

In addition, the server device collects pieces of trophy acquisition information transmitted by the plurality of information processing devices operated by the plurality of players and analyzes play trends concerning trophy acquisition of the users. For example, the server device may statistically derive an order of acquiring a trophy in one game, on the basis of the pieces of trophy acquisition information transmitted by the plurality of information processing devices.

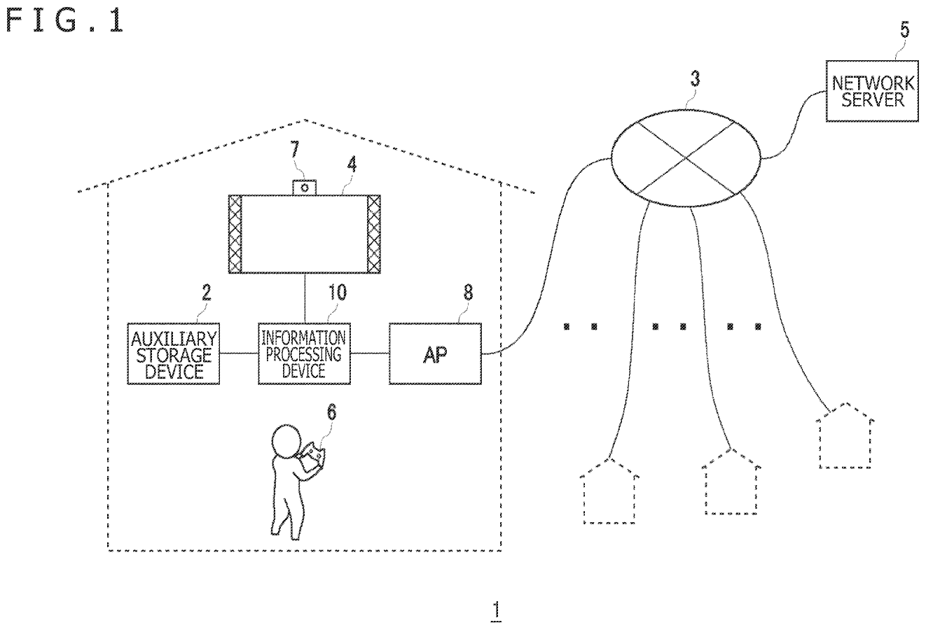

FIG. 1 illustrates an information processing system 1 according to the embodiment of the present disclosure. The information processing system 1 of the embodiment is a game system which supports a game play of a user, and includes an information processing device 10 that is operated by a user who is a player and a server device 5. An access point (hereinafter, referred to as an “AP”) 8 has a function of a wireless access point or a router, and the information processing device 10 is connected through the AP 8 to the server device 5 on the network 3 in a wireless or a wired manner so as to be able to communicate with the server device 5. FIG. 1 illustrates one user and one information processing device 10. However, the information processing system 1 illustrated in FIG. 1 is configured based on a premise that a plurality of information processing devices 10 which are operated by a plurality of users and the server device 5 are connected to each other through the network 3.

The information processing device 10 is connected to an input device 6 operated by a user in a wireless or a wired manner. The input device 6 outputs operation information indicating a result of operation by the user to the information processing device 10. When receiving the operation information from the input device 6, the information processing device 10 reflects the operation information in processing of system software or game software, and causes an output device 4 to output a result of the processing. In the information processing system 1, the information processing device 10 may be a game device (game console) that executes a game. The input device 6 may be a device such as a game controller which supplies the operation information of the user to the information processing device 10. Note that the input device 6 may be an input interface such as a keyboard or a mouse.

An auxiliary storage device 2 is a large capacity storage device such as a hard disk drive (HDD) or a solid state drive (SSD). The auxiliary storage device 2 may be a built-in type storage device or may be an external storage device connected to the information processing device 10 by a universal serial bus (USB) or the like. The output device 4 may be a television set including a display which outputs an image and a speaker which outputs sound. The output device 4 may be connected to the information processing device 10 via a cable or wirelessly.

A camera 7 also functioning as an imaging device is provided in the vicinity of the output device 4 to capture an image of a space around the output device 4. In FIG. 1, the camera 7 is attached to an upper portion of the output device 4 as an example. However, the camera 7 may be disposed on a side portion or a lower portion of the output device 4. In either case, the camera 7 may be disposed at a position at which to be able to capture an image of the user located in front of the output device 4. The camera 7 may be a stereo camera.

The server device 5 provides the user of the information processing system 1 with a network service. The server device 5 manages a network account (user account) by which each user is identified, and each user signs in to the network service provided by the server device 5, with use of the user's network account. The user signs in to the network service from the information processing device 10 so as to be able to register save data on a game or a trophy that is a virtual reward obtained during a game play in the server device 5. The server device 5 has the save data and the trophy registered therein, so that the user can synchronize the save data and the trophy, even when the user uses another information processing device that is different from the information processing device 10.

The server device 5 of the embodiment collects the pieces of event data from the plurality of information processing devices 10. The server device 5 processes pieces of information relating to each activity from the pieces of collected event data and, for example, derives an average length of playing time for each activity, an average timing at which the activity is played, and the like. In addition, the server device 5 statistically processes and derives an order in which the activities are to be carried out, so that, when the user has completed a certain activity, an activity that will highly possibly be carried out next can be specified.

In addition, the server device 5 of the embodiment collects pieces of acquisition information on the trophies acquired by the plurality of players from the plurality of information processing devices 10. The server device 5 analyzes play trends concerning the trophy acquisition, from the collected pieces of trophy acquisition information. Specifically, the server device 5 statistically processes and derives the order of acquiring the trophies, making it possible to specify a trophy which will highly possibly be acquired next when the user acquires a certain trophy.

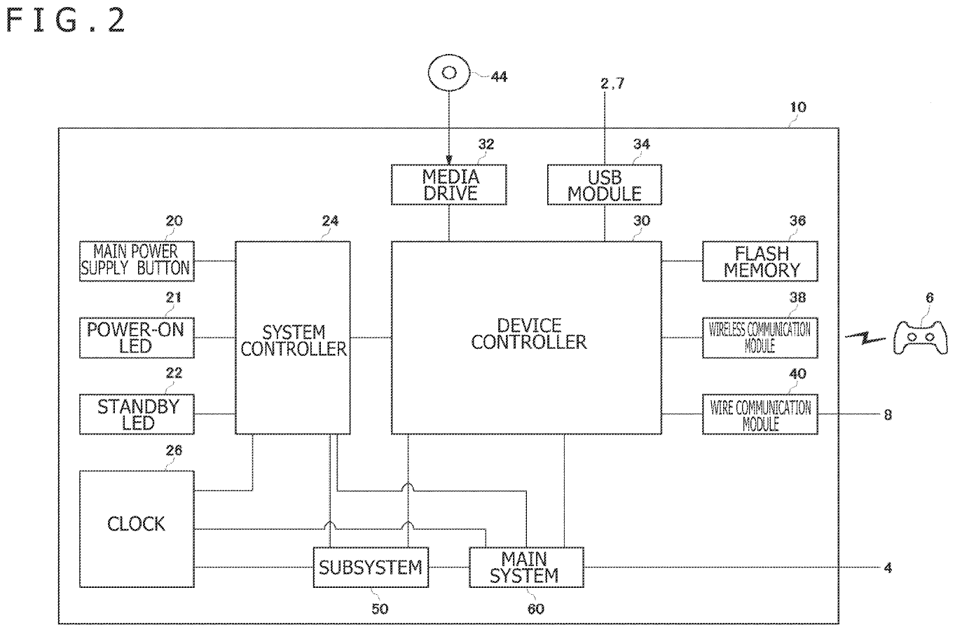

FIG. 2 illustrates a hardware configuration of the information processing device 10. The information processing device 10 includes a main power supply button 20, a power-on light-emitting diode (LED) 21, a standby LED 22, a system controller 24, a clock 26, a device controller 30, a media drive 32, a USB module 34, a flash memory 36, a wireless communication module 38, a wire communication module 40, a sub system 50, and a main system 60.

The main system 60 includes a main central processing unit (CPU), a memory as a main storage device, a memory controller, a graphics processing unit (GPU), and the like. The GPU is used mainly for computing processing of a game program. The main CPU has a function of activating the system software and executing the game program installed in the auxiliary storage device 2 under an environment provided by the system software. The sub system 50 includes a sub CPU, a memory as a main storage device, a memory controller, and the like. The sub system 50 does not include a GPU.

The main CPU has the game program installed in the auxiliary storage device 2, whereas the sub CPU does not have such a function. However, the sub CPU has a function of accessing the auxiliary storage device 2 and a function of sending and receiving data to and from the server device 5. The sub CPU has such a limited processing function only, and can thus be operated with power consumption lower than the power consumption in operation of the main CPU. These functions of the sub CPU are executed when the main CPU is in a standby state.

The main power supply button 20 is an input section by which operating input from the user is performed. The main power supply button 20 is provided to a front surface of a casing of the information processing device 10. The main power supply button 20 is operated to turn on or off the supply of power to the main system 60 of the information processing device 10. The power-on LED 21 is lit when the main power supply button 20 is turned on. The standby LED 22 is lit when the main power supply button 20 is turned off. The system controller 24 detects pressing down of the main power supply button 20 by the user.

The clock 26 is a real-time clock. The clock 26 generates the current date and time information and supplies the generated date and time information to the system controller 24, the sub system 50, and the main system 60.

The device controller 30 is configured as a large-scale integrated circuit (LSI) which executes delivery of information between devices like a south bridge. As illustrated in FIG. 2, such devices as the system controller 24, the media drive 32, the USB module 34, the flash memory 36, the wireless communication module 38, the wire communication module 40, the sub system 50, and the main system 60 are connected to the device controller 30. The device controller 30 absorbs differences between electrical characteristics of the respective devices and differences between data transfer rates, and controls data transfer timing.

The media drive 32 is a drive device that is loaded with the ROM medium 44 on which such application software as a game and license information are recorded, that drives the ROM medium 44 to read a program, data, and the like from the ROM medium 44. The ROM medium 44 is a read-only recording medium such as an optical disc, a magneto-optical disc, or a Blu-ray disc.

The USB module 34 is a module connected to an external device by a USB cable. The USB module 34 may be connected to the auxiliary storage device 2 and the camera 7 by a USB cable. The flash memory 36 is an auxiliary storage device forming an internal storage. The wireless communication module 38 performs wireless communication with the input device 6, for example, using a communication protocol such as a Bluetooth (registered trademark) protocol or Institute of Electrical and Electronic Engineers (IEEE) 802.11 protocol. The wire communication module 40 performs wire communication with an external device and is connected to the network 3 via the AP 8.

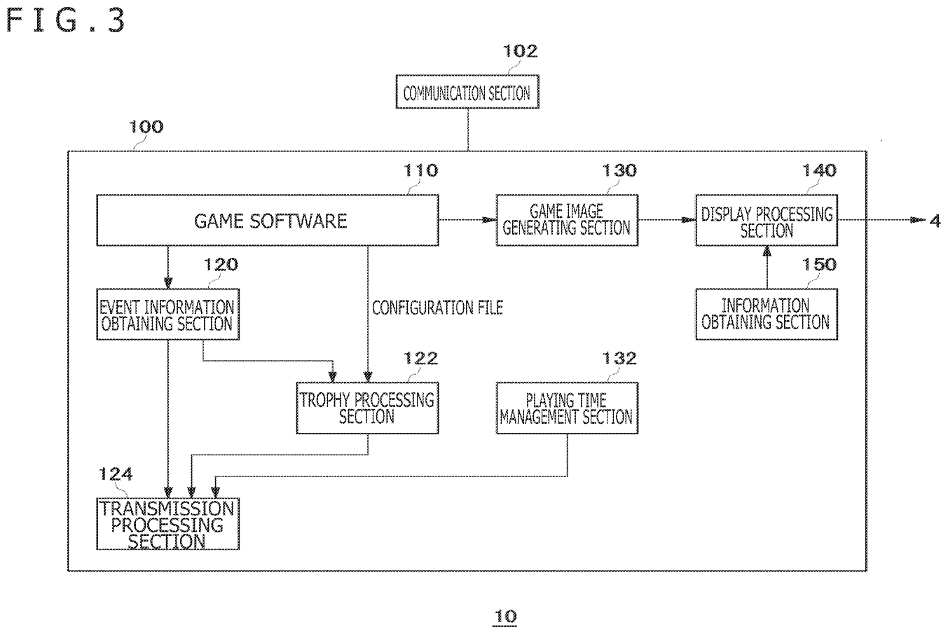

FIG. 3 illustrates functional blocks of the information processing device 10. The information processing device 10 includes a processing section 100. The processing section 100 includes a game software 110, an event information obtaining section 120, a trophy processing section 122, a transmission processing section 124, a game image generating section 130, a play time management section 132, a display processing section 140, and an information obtaining section 150.

The information processing device 10 includes a computer, and the computer executes a program, thereby achieving various functions indicated in FIG. 3. The computer has a memory in which a program is loaded, one or more processors that execute the loaded program, an auxiliary storage device, another LSI, and the like as hardware. The processor includes a plurality of electronic circuits including semiconductor integrated circuits and LSIs, and the plurality of electronic circuits may be mounted on a single chip or a plurality of chips. The functional blocks indicated in FIG. 3 are implemented in cooperation with hardware and software. Thus, it will be understood by those skilled in the art that these functional blocks may be variously implemented by hardware only, by software only, or by a combination of hardware and software.

The game software 110 includes at least a game program, image data, sound data, and a configuration file. The game program receives operation information on the input device 6 by the user, and executes computing processing for moving a game character in a virtual space. A game image generating section 130 includes a GPU which executes rendering processing and the like, and generates image data on a game. A display processing section 140 outputs the generated game image from the output device 4. Note that the processing section 100 includes a game sound generation section which generates game sound data and a sound output section which outputs game sound. However, illustration of them is omitted in FIG. 3.

When an event has occurred during progress of the game, the game program outputs event information indicating occurrence of the event. Upon obtaining the event information from the game software 110, an event information obtaining section 120 provides the obtained event information to a trophy processing section 122. In addition, the event information obtaining section 120 generates event data by adding the user account, the game ID, and time information (a time stamp) indicating the time of occurrence of the event are added to the event information, and provides the generated event data to the transmission processing section 124. Note that the game program may output the event information including the game ID and/or the time stamp to the event information obtaining section 120. The transmission processing section 124 transmits the generated event data to the server device 5 through the communication section 102.

In the game program, a start and an end of an activity are coded as an event. When the activity is started during the progress of the game, the game program outputs event information indicating occurrence of a starting event of the activity. When the activity is ended, the game program outputs event information indicating occurrence of an ending event of the activity. The game manufacturer may prepare various kinds of events in the game. For example, in a case in which a battle activity involving an enemy boss is incorporated in the game, the game program outputs event information indicating an activity ID identifying the battle activity and information indicating a start of the battle activity, when the battle is started. When the player wins in the battle against the enemy boss, the game program outputs event information including the activity ID identifying the battle activity, information indicating an end of the battle activity, and information indicating a success of the activity.

The transmission processing section 124 transmits event data relating to the activity performed by the player through the communication section 102 to the server device 5. In the information processing system 1, a process of transmitting event data is executed by all of the information processing devices 10 that are connected to the server device 5, and the server device 5 collects, from the plurality of information processing devices 10, pieces of event data relating to various kinds of activities included in various kinds of games. Note that the transmission processing section 124 transmits not only event data relating to the activity, but also event data having no relation to the activity, to the server device 5. Preferably, when the event information obtaining section 120 obtains the event information from the game software 110, the event information obtaining section 120 immediately generates event data having a time stamp added thereto, and the transmission processing section 124 transmits the event data to the server device 5.

For a purpose of increasing motivation of the user to the game play, various kinds of missions for acquiring a trophy are set in the game. When the user completes a mission, a trophy corresponding to the mission is rewarded to the user. A plurality of types of trophies that correspond to the difficulty of missions in the game may be prepared, and bronze, silver, and gold trophies in order from easiest difficulty may be prepared.

The configuration file included in the game software 110 records a correspondence relation between event information output from the game and a condition for unlocking the trophy. For example, the configuration file records an event “defeat a sub boss” as an unlock condition for the bronze trophy. Similarly, the configuration file records an event “defeat a middle boss” as an unlock condition for the silver trophy and an event “defeat the biggest boss” as an unlock condition for the gold trophy.

Upon receiving event information provided from the event information obtaining section 120, the trophy processing section 122 refers to the configuration file and preforms a process of determining whether or not the trophy unlock condition succeeds. When the trophy processing section 122 determines that the unlock condition succeeds, the trophy processing section 122 generates acquisition information of the unlocked trophy and provides the generated acquisition information to the transmission processing section 124. The trophy acquisition information includes identification information (game ID) for identifying the game, identification information (trophy ID) for identifying the unlocked trophy, and time information (time stamp) on the time at which the trophy has been unlocked.

The transmission processing section 124 transmits the generated trophy acquisition information through the communication section 102 to the server device 5. In the information processing system 1, a process of transmitting the trophy acquisition information is executed by all of the information processing devices 10 that are connected to the server device 5, and the server device 5 collects pieces of trophy acquisition information in various kinds of games from the plurality of information processing devices 10. It is preferred that, when the trophy processing section 122 generates the trophy acquisition information, the transmission processing section 124 immediately transmit the generated trophy acquisition information to the server device 5.

The playing time management section 132 manages a time at which the game software 110 is started and a time at which the game software 110 is ended. When the game software 110 is activated, the playing time management section 132 generates game start information including a game ID and a game starting time, and the transmission processing section 124 transmits the game staring information through the communication section 102 to the server device 5. In addition, when the game software 110 is ended, the playing time management section 132 generates game end information including the game ID and a game ending time, and the transmission processing section 124 transmits the game end information through the communication section 102 to the server device 5. Upon receiving the game start information and the game end information, the server device 5 can measure a length of time for which the game has been played in the information processing device 10.

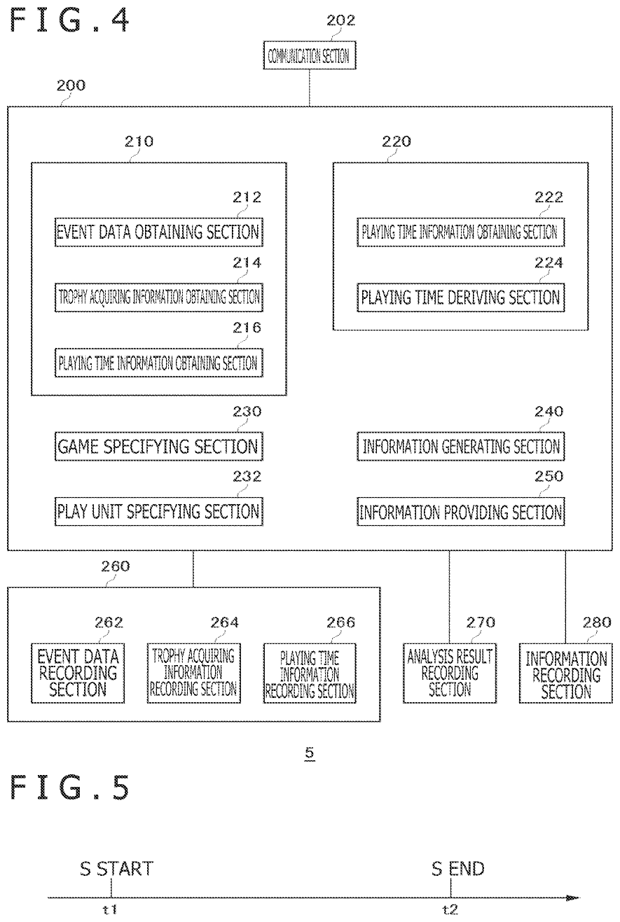

FIG. 4 indicates functional blocks of the server device 5 in the embodiment. The server device 5 includes a processing section 200, a communication section 202, a play data recording section 260, an analysis result recording section 270, and an information recording section 280. The processing section 200 includes a play data obtaining section 210, an analyzing section 220, a game specifying section 230, a play unit specifying section 232, an information generation section 240, and an information providing section 250. The play data obtaining section 210 has an event data obtaining section 212, a trophy acquisition information obtaining section 214, and a playing time information obtaining section 216. The analyzing section 220 has a playing time deriving section 222 and a play timing deriving section 224. The play data recording section 260 has an event data recording section 262, a trophy acquisition information recording section 264, and a playing time information recording section 266.

The server device 5 includes a computer, and the computer executes a program, thereby achieving various functions indicated in FIG. 4. The computer has a memory in which a program is loaded, one or more processors that execute the loaded program, an auxiliary storage device, another LSI, and the like as hardware. The processor includes a plurality of electronic circuits including semiconductor integrated circuits and LSIs, and the plurality of electronic circuits may be mounted on a single chip or a plurality of chips. The functional blocks indicated in FIG. 4 are implemented in cooperation with hardware and software. Thus, it will be understood by those skilled in the art that these functional blocks may be variously implemented by hardware only, by software only, or by a combination of hardware and software.

The play data obtaining section 210 obtains various types of data (hereinafter, also referred to as “play data”) resulting from a plurality of players having played the game, and records the pieces of data in the play data recording section 260. The play data is data generated in relation to the game play and may include at least event data, trophy acquisition information, playing time information on the game. The play data recording section 260 records pieces of play data indicating situations, results, or the like when the plurality of players played the game in the past.

The event data obtaining section 212 obtains pieces of event data regarding the activity performed by the plurality of players, from the plurality of information processing devices 10, and records the pieces of event data in the event data recording section 262. The event data recording section 262 records the pieces of event data in association with the network account of each player, for each game title. As described above, the event data includes at least the game ID, the activity ID, the information indicating the start and end of the activity, and the time stamp. Note that the event data obtaining section 212 may obtain the event data having no relation to the activity and record the event data in the event data recording section 262.

The playing time information obtaining section 216 obtains, from the plurality of information processing devices 10, obtains pieces of game start information and pieces of game end information, and records the obtained pieces of information to the playing time information recording section 266. The playing time information recording section 266 records the play starting time and the play ending time, in association with the network account of each player, for each game title.

Hereinafter, an example in which the analyzing section 220 analyzes pieces of past play data on a game X having been played by a plurality of players and obtains information indicating a play history relating to an activity will be described. As described above, the activity is a play unit to which an end condition is at least set in the game, and the analyzing section 220 analyzes the pieces of past play data on the game X having been played by the plurality of players, to thereby derive an average length of playing time and an average play timing for each of a plurality of activities.

The playing time deriving section 222 obtains a playing time for the activity for each player. The playing time deriving section 222 obtains the lengths of playing time of the plurality of players for the activity, from the pieces of event data (start event data) including activity start event information and event data (end event data) including activity end event information, which are recorded in the event data recording section 262. Playing time for an activity is calculated on the basis of a time stamp included in the start event data and a time stamp included in the end event data.

FIG. 5 is a diagram used for describing a calculation method for a playing time. FIG. 5 indicates a start event and an end event of the activity S performed by a single player. Specifically, “S START” represents the start event of the activity S, and “S END” represents the end event of the activity S. The start event data includes a start time t1 of the activity S, while the end event data includes an end time t2 of the activity S. The playing time deriving section 222 calculates the playing time of the player for the activity S to be (t2−t1). The playing time deriving section 222 records the calculated playing time for the activity S in the analysis result recording section 270, in association with the network account of the player, along with the game ID and the activity ID. Similarly, the playing time deriving section 222 calculates the lengths of playing time of the other players for activity S and records the calculated lengths of playing time for the activity S in the analysis result recording section 270, in association with the network account of the other players, along with the game ID and the activity ID.

The playing time deriving section 222 performs averaging processing on the derived lengths of playing time of all of the players for the activity S of the game X and derives an average length of playing time for the activity S, to record it in the analysis result recording section 270. The playing time deriving section 222 also derives average lengths of playing time for other activities and records the average lengths of playing time for all of the activities in the game X in the analysis result recording section 270.

The play timing deriving section 224 obtains a play timing for each activity in the game X. The play timing means a timing at which a player who has completed the game X (a player who have completed the final stage) has played each activity.

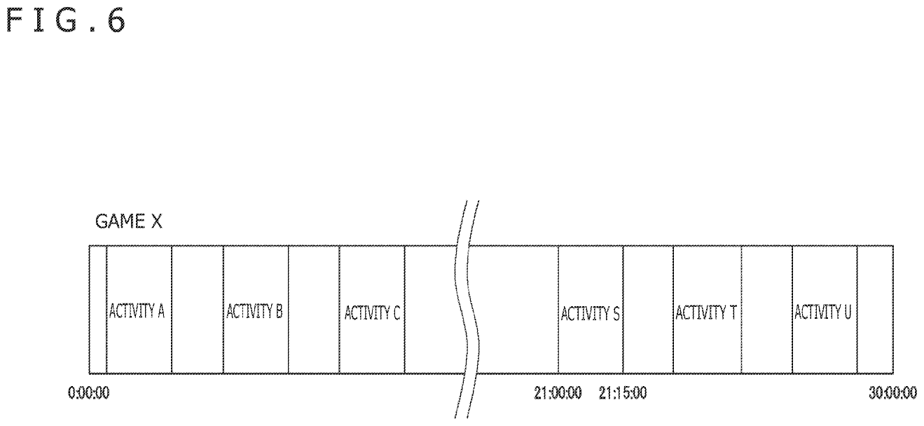

FIG. 6 is a diagram used for describing a calculation method for a play timing. FIG. 6 indicates a playing situation from a timing at which a single player starts to play the game X to a timing at which to complete the game X. Specifically, this playing situation indicates a situation in which the player has completed from the first stage to the final stage of the game X.

In an example indicated in FIG. 6, the player has completed the game X in 30 hours. The play timing deriving section 224 refers to the recorded contents in the playing time information recording section 266, specifies a period of time for which the player has played the game X, and creates a time table for the activity performed by the player with reference to the recorded contents in the event data recording section 262. The play timing deriving section 224 can specify the timing at which the player performed each activity by creating the time table indicated in FIG. 6.

For example, the activity S was played 21 hours later after the player had started the game X. The play timing deriving section 224 derives the fact that the player played the activity S at a timing at which 70% (=21 hours/30 hours) of the total length of playing time of the game X had passed. In the embodiment, the play timing deriving section 224 derives the play timing for the activity S as 70% and records the derived play timing in association with the network account of the player along with the game ID and the activity ID in the analysis result recording section 270. Similarly, the play timing deriving section 224 derives the play timings of the other players for the activity S and records the derived play timings in association with the network account of the other players along with the game ID and the activity ID in the analysis result recording section 270.

The play timing deriving section 224 performs averaging processing on the play timings of all the players for the activity S of the game X and derives an average play timing for the activity S, to record the average play timing in the analysis result recording section 270. The play timing deriving section 224 derives average play timings for all of the activities included in the game X and records the derived average play timings in the analysis result recording section 270. Note that a player whose play timing is to be derived is a player who has completed the game X, and a player who has not completed the game X yet is exempt from the play timing deriving processing executed by the play timing deriving section 224.

In a case in which there are plenty of past play data in the game X, the playing time deriving section 222 can derive the average length of playing time of each activity with high accuracy. In a case in which the average length of playing time for an activity can be derived with high accuracy, the server device 5 presents the average length of playing time for the relevant activity to a user who has not played the relevant activity, allowing the user to estimate a length of playing time taken for the relevant activity to play. However, if the game X is just released and the server device 5 has not been able to collect the past play data on the game X enough, the playing time deriving section 222 may not derive the average length of playing time for each activity.

In view of this, in the embodiment, in a case in which the past play data on the game X is not enough, the server device 5 has a function of making use of past play data on another game which has a predetermined relation to the game X, that is, which is close in game configuration to the game X, generating information relating to the game X, and providing the generated information to a user.

To realize this function, the game specifying section 230 specifies another game having a predetermined relation to the game. The game specifying section 230 may specify a game which is close in game configuration to the game X, with reference to attribute information of the game X. For example, in a case in which the game X is the latest work in the series, the game specifying section 230 specifies old games in the series released earlier than the game X in the past. In a case in which the game X is part of the series, the old games tend to have the similar game configuration to that of the game X and are often similar in activity and trophy to the game X.

In addition, the game specifying section 230 may specify a game of the same genre produced by the same manufacturer as the game X. In addition to this, the game specifying section 230 may specify a game which is similar in game configuration to the game X. In the following description, a case in which the game specifying section 230 specifies, as games having a predetermined relation to the game X, a game X′ which is an old game in the series of the game and a game Y of the same genre manufactured by the same manufacturer as that of the game X will be described. Note that the game having a predetermined relation to the game X may be specified by a manager operating the server device 5 manually.

In the embodiment, the play data recording section 260 records pieces of past play data of a plurality of players on all games that are distributed in the information processing system 1. Hence, the play data recording section 260 records pieces of past play data of a plurality of players on the game X′ and the game Y, each of which has a predetermined relation to the game X.

In addition, the analyzing section 220 analyzes the pieces of past play data on all of the games recorded in the play data recording section 260 and obtains information indicating a play history relating to each of a plurality of activities, to record the information in the analysis result recording section 270. In the embodiment, the playing time deriving section 222 derives the average length of playing time for all activities included in the game X′ and records it in the analysis result recording section 270, while recording the average length of playing time for all activities included in the game Y in the analysis result recording section 270. Similarly, the play timing deriving section 224 derives the average play timing for all the activities included in the game X′ and records it the analysis result recording section 270, while deriving an average play timing for all the activities included in the game Y and recording it in the analysis result recording section 270.

The play unit specifying section 232 specifies activities in the game X′ and the game Y which are similar to activities in the game X.

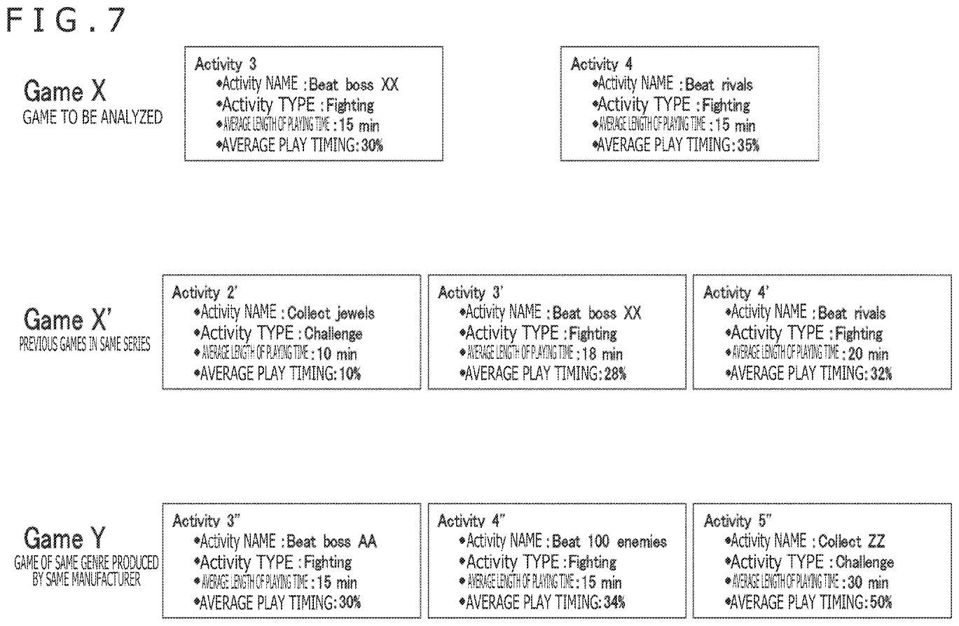

FIG. 7 is a diagram used for describing a process of specifying activities in the game X′ and the game Y which are similar to the activity 3 in the game X. The play unit specifying section 232 may specify the respective activities in the game X′ and the game Y which are similar to the activity 3 in the game X, on the basis of at least one of a name of the activity, a type of the activity, and a description of the activity, which are set in each game, in order to find a similar activity. Activity attribute information such as the name, the type, and the description thereof is included in each game software, and the play unit specifying section 232 fetches these pieces of attribute information from each game software and refers to them. Note that the server device 5 may be supplied from the game manufacturer with the activity attribute information.

In FIG. 7, the play unit specifying section 232 finds out an activity similar to the activity 3 in the game X between the game X′ and the game Y. First, the play unit specifying section 232 specifies the attribute information on the activity 3 in the game X as below. A description of the activity in this example is omitted.
Activity name: Beat Boss XX
Activity type: Fighting

In addition, the play unit specifying section 232 refers to the analysis result recording section 270 and specifies information indicating a play history relating to the activity 3 in the game X as below.
Average length of playing time: 15 minutes
Average play timing: 30%

Note that, if the game X has just been released and play data on the activity 3 has not been accumulated in the play data recording section 260, the analyzing section 220 may not analyze the play data on the activity 3. Accordingly, the play unit specifying section 232 may not obtain the play history information described above.

The play unit specifying section 232 specify, on the basis of the attribute information and play history information on the activity, similar activities in the game X′ and the game Y. In the example of FIG. 7, the play unit specifying section 232 specifies the attribute information on an activity 3′ in the game X′ as described below.
Activity name: Beat Boss XX
Activity type: Fighting

In addition, the play unit specifying section 232 refers to the analysis result recording section 270 and specifies information indicating a play history relating to the activity 3′ in the game X′ as below.
Average length of playing time: 18 minutes
Average play timing: 28%

The play unit specifying section 232 compares the attribute information and the play history information between the activity 3 in the game X and the activity 3′ in the game X′ and may determine that the activity 3 in the game X and the activity 3′ in the game X′ are similar to each other. Specifically, the play unit specifying section 232 may determine that the activity 3 in the game X and the activity 3′ in the game X′ are similar to each other, since the activity name and the activity type are identical to each other and the average length of playing time and the average play timing are substantially identical to each other. Note that the play history information on the game X is derived from a few samples, which may not be said to be highly reliable. Hence, the play unit specifying section 232 may determine that the activity 3 and the activity 3′ are similar to each other by putting more importance to a degree of coincidence for attribute information between the activity 3 and the activity 3′ than a degree of coincidence for the play history information.

In addition, in the example indicated in FIG. 7, the play unit specifying section 232 specifies the attribute information on an activity 3″ in the game Y as below.
Activity name: Beat Boss AA
Activity type: Fighting

In addition, the play unit specifying section 232 refers to the analysis result recording section 270 and specifies information indicating a play history relating to the activity 3″ in the game Y as below.
Average length of playing time: 15 minutes
Average play timing: 30%

The play unit specifying section 232 compares the attribute information and the play history information between the activity 3 in the game X and the activity 3″ in the game Y and may determine that the activity 3 in the game X and the activity 3″ in the game Y are similar to each other. Specifically, since the activity names are similar to each other, the activity types are identical to each other, and the average length of playing time and the average play timing are identical to each other, the play unit specifying section 232 may determine that the activity 3 in the game X and the activity 3″ in the game Y are similar to each other.

When the play unit specifying section 232 specifies the activity which is similar to the activity 3 in the game X, the information generation section 240 generates information relating to the activity 3 in the game X, on the basis of the obtained information indicating the play history relating to the activity similar to the activity 3 and records the generated information in the information recording section 280. In the above-described example, the information generation section 240 generates the information relating to the activity 3 in the game X, on the basis of the obtained information indicating the play history relating to the activity 3′ in the game X′ and/or the activity 3″ in the game Y.

For example, the information generation section 240 may generate information relating to a length of time taken to play the activity 3 in the game X, on the basis of the average length of playing time for the activity 3′ and/or the average length of playing time for the activity 3″. In the embodiment, the average length of playing time of each of the activity 3, the activity 3′, and the activity 3″ are derived as below.
Activity 3: 15 minutes
Activity 3′: 18 minutes
Activity 3″: 15 minutes

Here, in a case in which the average length of playing time (15 minutes) for the activity 3 in the game X is calculated from an insufficient amount of play data, the average length of playing time may not be said to be accurate. In this case, the information generation section 240 may calculate the information relating to a length of time taken to play the activity 3 from the average length of playing time for the activity 3′ in the game X′ and/or the average length of playing time for the activity 3″ in the game Y. When the average length of playing time for the activity 3′ is defined as “3′_avg_time” and the average length of playing time for the activity 3″ as “3″_avg_time,” the information generation section 240 may calculate an estimated average length of playing time for the activity 3 with use of the following Equation (1).

(Estimated average length of playing time for activity 3)=α×3′_avg_time+β×3″_avg_time (Equation (1))
Here, α+β=1

For example, a ratio of a coefficient α to a coefficient β may be set according to a ratio of the number of samples used in calculation of the average length of playing time for the activity 3′ to the number of samples used in calculation of the average length of playing time for the activity 3″ (set to be equal, for example). In addition, the coefficient α of the activity 3′ in the game X′ which is part in the same series may be set greater than the coefficient β of the activity 3″ in the game Y which is not part in the same series. For example, in a case in which the coefficient α=⅔ and the coefficient β=⅓ are set, the estimated average length of playing time for the activity 3 is 17 minutes. The information generation section 240 records the calculated estimated average length of playing time for the activity 3 in the information recording section 280.

Note that the average length of playing time (15 minutes) for the activity 3 in the game X is calculated from an insufficient amount of play data. It is, however, reliable to some degrees. Accordingly, the information generation section 240 takes into account the average length of playing time (3_avg_time) of the activity 3, the estimated average length of playing time for the activity 3 may be calculated with use of the following Equation (2).

(Estimated average length of playing time for the activity 3)=α×3_avg_time+β×3′_avg_time+γ×3″_avg_time (Equation (2))
Here, α+β+γ=1

At this time, the coefficient α is preferably smaller than the coefficients β and γ.

The information generation section 240 calculates the estimated average length of playing time for an activity other than the activity 3 in the game X. The information generation section 240 records the calculated estimated average length of playing time for the activity in the information recording section 280.

The information providing section 250 notifies the user who operates the information processing device 10 of an estimated average length of playing time for an activity which has not been performed yet by the user. The information providing section 250 may notify the user of the estimated average length of playing time, at any desired timing.

In the information processing device 10, the information obtaining section 150 obtains, from the server device 5, information relating to the estimated average length of playing time for the activity 3. The display processing section 140 displays the information obtained by the information obtaining section 150.

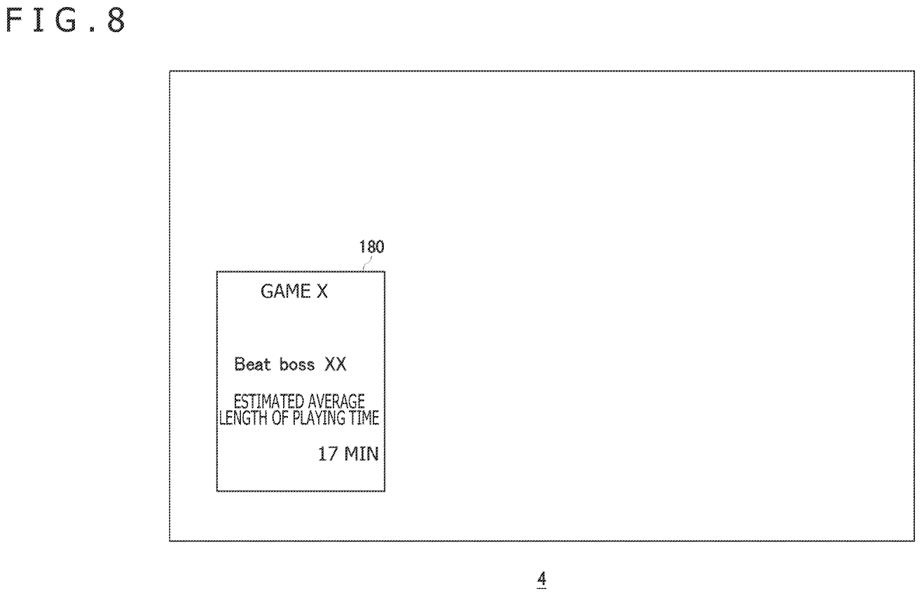

FIG. 8 illustrates an example of a system screen displayed on the output device 4. The display processing section 140 generates a system image 180 from the information obtained by the information obtaining section 150 and displays the system image on the output device 4. In the system image 180, the activity name “Beat boss XX” of the activity 3 in the game X and the estimated average length of playing time “17 minutes” are displayed. The system image 180 displayed in a form of a card may be a graphical user interface (GUI), and when the user selects the system image 180, the activity 3 corresponding to the system image 180 may automatically be started.

In addition, the information generation section 240 may generate information indicating an activity which is recommended to be played next to the activity 3 in the game X. In the analyzing section 220, the play timing deriving section 224 derives the average play timings of all of the activities included in each game and records the derived average play timings in the analysis result recording section 270. The play timing deriving section 224 derives the average play timings of all the activities, and accordingly, an order of performing a plurality of activities (for example, such a time table as that indicated in FIG. 6) may be recognized. Hence, the information generation section 240 can specify an activity having a tendency to be played next to the activity 3′ in the game X′ and an activity having a tendency to be played next to the activity 3″ in the game Y.

Note that the analyzing section 220 statistically processes pieces of event data transmitted from a plurality of information processing devices irrespective of the play timing and may extract a relation regarding a play order of activities. For example, in a case in which the percentage in which a player who has played the activity 3′ will play the activity 4′ next is 80% or higher in the game X′, the analyzing section 220 recognizes that there is a tendency that the activity 4′ is to be played next to the activity 3′. In addition, in a case in which the percentage in which a player who has played the activity 3″ will play the activity 4″ next is 80% or higher in the game Y, the analyzing section 220 recognizes that there is a tendency that the activity 4″ is to be played next to the activity 3″.

With use of the play order of the activities specified in each of the game X′ and the game Y, the information generation section 240 may find, in the game X, an activity which is recommended to be played next to the activity 3 in the game X. Specifically, the information generation section 240 may set an activity in the game X which is similar to the activity 4′ in the game X′ and/or the activity 4″ in the game Y as an activity which is recommended to be played next to the activity 3. Note that the activity in the game X which is similar to the activity 4′ in the game X′ and/or the activity 4″ in the game Y is searched by the play unit specifying section 232. When the play unit specifying section 232 specifies that the activity in the game X which is similar to the activity 4′ in the game X′ and/or the activity 4″ in the game Y is the activity 4, the information generation section 240 generates information indicating the activity 4 which is recommended to be played next to the activity 3, as information relating to the activity 3.

The information providing section 250 provides, to the user who operates the information processing device 10, information indicating the activity 4 which is recommended to be played next to the activity 3 which has been played by the user. The information providing section 250 may notify the user of information on the activity which is recommended at any desired timing.

In the information processing device 10, the information obtaining section 150 obtains, from the server device 5, the information on the activity which is recommended. The display processing section 140 displays the information obtained by the information obtaining section 150.

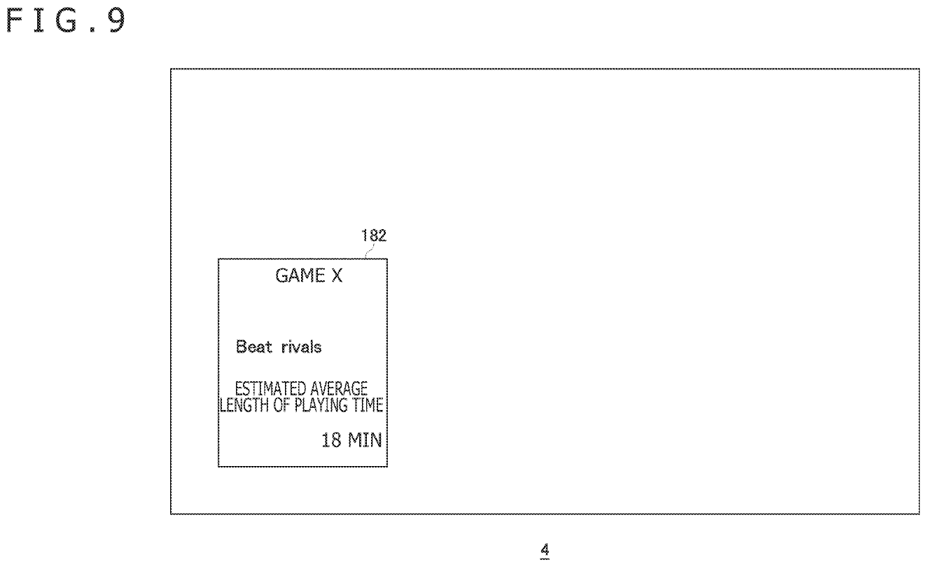

FIG. 9 illustrates an example of a system screen which is displayed on the output device 4. The display processing section 140 generates a system image 182 from the information obtained by the information obtaining section 150 and displays the generated system image 182 on the output device 4. In the system image 180, the activity name “Beat rivals” of the activity 4 in the game X and the estimated average length of playing time “18 minutes” are displayed. The system image 182 displayed in the form of a card may be a GUI, and when the user selects the system image 182, the activity 4 corresponding to the system image 182 may automatically be started.

The present disclosure has been described above on the basis of the embodiment thereof. The foregoing embodiment is illustrative, and it is to be understood by those skilled in the art that combinations of constituent elements and processing processes of the embodiment are susceptible of various modifications and that such modifications also fall within the scope of the present disclosure. In the embodiment, although an activity is indicated as an example of a play unit, the play unit may include a mission for acquiring a trophy. Alternatively, the play unit may include a stage, a quest, a mission, a tournament, a session, or the like, to which an activity or a trophy is not set.

1. A server device comprising:
a recording device which records pieces of past play data of a plurality of players on a second game having a predetermined relation to a first game; and
one or more processors having hardware,
wherein the one or more processors
analyze the pieces of past play data on the second game and obtain information indicating a play history relating to a plurality of play units to each of which an end condition is set in the second game,
specify a second play unit in the second game which is similar to the first play unit in the first game, and
generate information relating to the first play unit in the first game, on a basis of the information indicating the obtained play history relating to the second play unit in the second game.

2. The server device according to claim 1, wherein the one or more processors specify the second play unit in the second game which is similar to the first play unit in the first game, on a basis of at least one of a name of a play unit, a type of the play unit, and a description of the play unit, which are set in each of the first game and the second game.

3. The server device according to claim 1, wherein
the recording device records the pieces of past play data of the plurality of players on the first game, and
the one or more processors
analyze the pieces of past play data in the first game and obtain information indicating a play history relating to a plurality of play units to each of which an end condition is set in the first game, and
specify the second play unit in the second game which is similar to the first play unit in the first game, on a basis of the information indicating the play history relating to the plurality of play units in each of the first game and the second game.

4. The server device according to claim 1, wherein the one or more processors generate, as the information relating to the first play unit, information relating to a time at which the first play unit was played.

5. The server device according to claim 1, wherein the one or more processors generate, as the information relating to the first play unit, information indicating a play unit which is recommended to be played next to the first play unit.

6. A method of providing information to a user, comprising:
analyzing pieces of past play data of a plurality of players on a second game having a predetermined relation to a first game to obtain information indicating a play history relating to a plurality of play units to each of which an end condition is set in the second game;
specifying a second play unit in the second game which is similar to a first play unit in the first game;
generating information relating to the first play unit in the first game, on a basis of the information indicating the obtained play history relating to the second play unit in the second game; and
providing the information relating to the first play unit in the first game to a user.

7. A non-transitory, computer-readable storage medium containing a computer program, which when executed by a computer, causes the computer to implement a method of providing information to a user by carrying out actions, comprising:
analyzing pieces of past play data of a plurality of players on a second game having a predetermined relation to a first game to obtain information indicating a play history relating to a plurality of play units to each of which an end condition is set in the second game;
specifying a second play unit in the second game which is similar to a first play unit in the first game;
generating information relating to the first play unit in the first game, on a basis of the information indicating the obtained play history relating to the second play unit in the second game; and
providing the information relating to the first play unit in the first game to a user.
